(19) United States
(12) Patent Application Publication
(10) Pub. No.: US 2006/0069816 A1
(43) Pub. Date: Mar. 30, 2006

(54) Recording media drive and control method for power-save modes thereof

(75) Inventors: Hiroshi Oshikawa, Kanagawa (JP); Hirofumi Saitoh, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/230,690

(22) Filed: Sep. 19, 2005

(30) Foreign Application Priority Data
Sep. 30, 2004 (JP) 2004-287821

(51) Int. Cl. G06F 3/00

(52) U.S. Cl. 710/14

(57) ABSTRACT

Embodiments of the invention improve power management in a data storage device which executes serial data communication with a host. In one embodiment, a HDD executes a reset process from a sleep mode (clock inactive) as being triggered by a control signal that is not based on a clock from the host. Even during a period in which the system clock is suspended, the HDD is able to receive the control signal from the host. In responding to the control signal and by activating a circuit required for serial data transmission, the HDD is enabled to receive a software reset command from the host via a serial data transmission circuit. With such an arrangement, the HDD can receive the software reset command from the host, and in responding to the reception of the command, the HDD can be reset to the normal active mode.

### CROSS-REFERENCES TO RELATED APPLICATIONS

This application claims priority from Japanese Patent Application No. JP2004-287821, filed Sep. 30, 2004, the entire disclosure of which is incorporated herein by reference.

### BACKGROUND OF THE INVENTION

The present invention relates to a recording media drive and a control method for power-save modes in a recording media drive, and more specifically to power-save mode control in a recording media drive which executes serial data communications.

Devices using various types of media such as optical disks and magnetic tapes are known as information recording and reproducing devices. Among them, hard disk drives (HDDs) have become popular as storage devices for computers to such an extent that they are one of the storage devices indispensable for today's computers. Further, not limited to computers, their application is widening more and more due to the superior characteristics with the advent of moving picture recording/reproducing devices, car navigation systems, removable memories for digital cameras and so on.

Each magnetic disk used in HDDs has a plurality of tracks formed concentrically and each track is partitioned into a plurality of sectors. Each sector has sector address information and user data stored thereon. A head element accesses the desired sector in accordance with the sector address information, thereby making it possible to execute data writing or reading to or from the sector.

A signal read by the head element from a magnetic disk in a data reading process is subjected to a given signal processing such as waveform shaping and decoding in a signal processing circuit and is then transmitted to a host. The transfer data from the host is similarly processed as stated above by the signal processing circuit and is then written on a magnetic disk.

In general, an interface to transmit data between the host and the HDD uses protocols such as the SCSI interface or the ATA interface. In particular, the SCSI interface is used for many computers from the viewpoint of improved functions and economical cost of the interface, and it is also used as an interface for other types of storage devices such as an optical disk storage device. In the quest for improved recording density of recording media and improved performance, requirements for data transfer speed of ATA interfaces are becoming increasingly severe.

For the above-stated reasons, an ATA interface using serial data transfer has been proposed as a substitute for conventional transmission systems using parallel data transmission. The Serial ATA (SATA) Standard is being formulated by the Serial ATA Working Group and is stated in detail, for example, in the Specifications (Non-Patent Document 1, “Serial ATA: High Speed Serialized ATA Attachment Revision 1.0a” [Retrieved on Sep. 23, 2004] The Internet <URL: http://www.sata-io.org/specifications.asp>) prepared by the Serial ATA Working Group.

On the other hand, to reduce consumption power in HDDs, various power management methods have been proposed (refer to Patent Document 1, Japanese Patent Laid-open No. 2000-173152, for example). Typically, an HDD is provided with a plurality of power-save mode, and switching is made to a prescribed power-save mode according to the number of commands from the host in a given period of time. In addition, for the SATA, power-save modes for serial interface are proposed. For the power-save modes, two modes are proposed according to time required for resetting, that is, the Partial state having shorter reset time and the Slumber state having longer recovery time.

### BRIEF SUMMARY OF THE INVENTION

As one of the power-save modes, a mode accompanying an inactive system clock (hereinafter referred to as the “sleep mode”) is known. With the conventional parallel ATA (PATA), basically two methods are prepared for resetting an HDD which is in the sleep mode to the normal active mode. One method is software reset and the other is hardware reset. The hardware reset corresponds to turning on of power of the HDD and it initializes the HDD control circuit.

For the above-stated reason, software reset is normally used to reset the HDD to the active mode while retaining data stored in a register without initializing the HDD. The host requests the HDD to execute software reset by setting a flag to the device control register of the HDD. The HDD is, in responding to the flag of the device control register, reset to the active mode from the sleep mode.

However, with the SATA, unlike the PATA, if a clock has not been generated in the HDD, it is not possible to transmit and receive a software reset command through serial data transmission. Therefore, the host cannot request the HDD to execute software reset.

The present invention has been made under the above-described background, and a feature of the invention is to improve power management of a recording media drive when data communications are executed through serial data transmission between a recording media drive, such as a HDD, and a host.

According to a first aspect of the present invention, there is provided a recording media drive, which executes serial data communication with a host according to a clock. The recording media drive includes: a receiver which receives a request switching to a power-save mode accompanying an inactive system clock from the host through serial data communication; a transmitter which transmits, in responding to the switching request received, an approval request for the host to execute a mode-switching request according to a control signal that is not based on a clock to the host through serial data communication; a controller which instructs, when judging that the approval is received from the host, an internal circuit to stop a system clock and to be switched to the power-save mode; and a system clock generator which stops generating a system clock in responding to an instruction from the controller.

Thus, the approval for the host is requested to execute a mode-switching request according to a control signal that is not based on a clock. This makes it possible to transmit a mode-switching request through serial data communication to the recording media drive from the host, even if a clock is inactive.

The controller, when judging that the approval has not been received, does not instruct to stop the system clock, and the system clock generator continues generating the system clock. With such an arrangement, it is possible to transmit the mode-switching request through serial data communication to the recording media drive, even when the host does not transmit a control signal that is not based on a clock.

The recording media drive further includes a control signal detector which instructs, when the control signal from the host is detected, resetting of a circuit required for serial data communication. Further, the receiver is reset according to the instruction from the control signal detector, the receiver receives a mode-switching request from the host through serial data communication, and the media drive is switched to a mode associated with the mode-switching request received through serial data communication. Furthermore, the mode-switching request requests resetting of the media drive to the normal active mode.

Alternatively, when the control signal from the host is detected, at least part of the internal circuit is retained in suspend status. With such an arrangement, it is possible to reduce consumption power.

Alternatively, an instruction from the control signal detector resets the receiver, the transmitter, the system clock generator and the controller and retains part of the inner circuit in suspend status, the receiver receives a mode-switching request from the host through serial data communication, and the controller instructs the inner circuit to be switched to a mode associated with the mode-switching request received through serial data communication.

In responding to the mode-switching request to the power-save mode, at least part of the internal circuit that is unnecessary for serial data communication is shut down. With the arrangement, it is possible to reduce consumption power.

To ensure approval to execute a mode-switching request from the host according to the control signal that is not based on a clock, approval to switch the transmitter and the receiver to a power-save mode is requested, the transmitter and the receiver is switched to the power-save mode in responding to reception of the approval for the request from the host, and the system clock is stopped.

According to a second aspect of the present invention, there is provided a recording media drive which executes serial data communication with a host according to a clock. The recording media drive includes: a receiver which receives a request switching to a power-save mode accompanying an inactive system clock from a host through serial data communication; a transmitter which, in responding to the switching request received, transmits an approval request for the host to transmit a reset request signal that is not based on a clock to the host; a controller which outputs a suspend instruction of part of the internal circuit in responding to the mode-switching request to judge if the approval has been received or not from the host; and a system clock generator which continuously generates a system clock when the controller judges that the approval has not been received.

With the arrangement, for a case where the host does not transmit a control signal that is not based on a clock, it is possible to transmit the mode-switching request through serial data communication to the recording media from the host.

According to a third aspect of the present invention, there is provided a control method for a power-save mode in a recording media drive which executes serial data communication with a host according to a clock. The control method includes the steps of receiving a mode-switching request to a power-save mode accompanying an inactive system clock, requesting approval for the host to transmit a control signal that is not based on a clock to the host, and stopping a system clock in responding to reception of the approval from the host.

Thus, the approval for the host is requested to execute the mode-switching request according to a control signal that is not based on a clock. This makes it possible to transmit the mode-switching request through serial data communication to the recording media drive from the host, even if a clock is inactive.

The control method further includes the steps of receiving the control signal from the host, restarting a circuit required for serial data communication in responding to the control signal, receiving a mode-switching request through serial data communication from the host, and switching to a mode associated with the mode-switching request received through serial data communication. Furthermore, in responding to the control signal, the circuit required for serial data communication are restarted while part of the internal circuit is retained in suspend status.

The control method further includes the step of shutting down part of the internal circuit in responding to reception of the mode-switching request to the power-save mode. The mode-switching request received through serial data communication requests resetting of the recording media drive to the normal active mode. To ensure approval for the host to transmit the control signal that is not based on a clock, approval to switch the serial interface to the power-save mode is requested, the serial interface is switched to the power-save mode in responding to reception of the approval for the request from the host, and the system clock is stopped.

According to a fourth aspect of the present invention, there is provided a control method for a power-save mode in a media drive which executes serial data communication with a host according to a clock. The control method includes the steps of receiving a mode-switching request to a power-save mode accompanying an inactive system clock, requesting approval for the host to transmit a control signal that is not based on a clock to the host, and retaining a system clock when the approval is not received from the host.

With the arrangement, for a case where the host does not transmit the control signal that is not based on a clock, it is possible to transmit the mode-switching request through serial data communication to the recording media from the host.

Further, in responding to the mode-switching request to the power-save mode, at least part of the internal circuits that are unnecessary for serial data communication is suspended. With the arrangement, it is possible to reduce consumption power.

According to the present invention, it is possible to improve power management in a recording media drive which executes serial data communications with a host.

### BRIEF DESCRIPTION OF THE DRAWINGS

FIG. 1 is a block diagram showing a schematic configuration of an HDD according to one embodiment of the present invention.

FIG. 2 is a block diagram showing a schematic configuration of the HDD according to the embodiment.

FIG. 3 is a flow chart showing a process associated with a request for switching to the sleep mode (clock inactive) and software reset in the HDD according to the embodiment.

FIG. 4 is a block diagram showing a schematic configuration of part of circuits in the HDC/MPU according to the embodiment.

FIG. 5 is a sequence diagram showing a process switching to the sleep mode (clock inactive) in a case where a host supports out-of-band control signals in a system according to the embodiment.

FIG. 6 is a sequence diagram showing a reset process to the normal active mode by means of software reset in a case where a host supports out-of-band control signals in a system according to the embodiment.

FIG. 7 is a sequence diagram showing a process switching to a power-save mode in a case where a host does not support out-of-band control signals in a system according to the embodiment.

FIG. 8 is a sequence diagram showing a reset process to the normal active mode in a case where a host does not support out-of-band control signals in a system according to the embodiment.

### DETAILED DESCRIPTION OF THE INVENTION

Hereinafter, specific embodiments to which the present invention is applicable will be described. To clearly articulate the description, descriptions and drawings stated hereunder are partially omitted and simplified as appropriate. In addition, for those skilled in the art, it is possible to easily make modifications, addition or transformations in each component of the following embodiments without departing from the spirit and scope of the present invention. It should be noted that, in each drawing, like reference numerals are given to the same components, and the redundant descriptions thereof are omitted as required to clearly articulate the description.

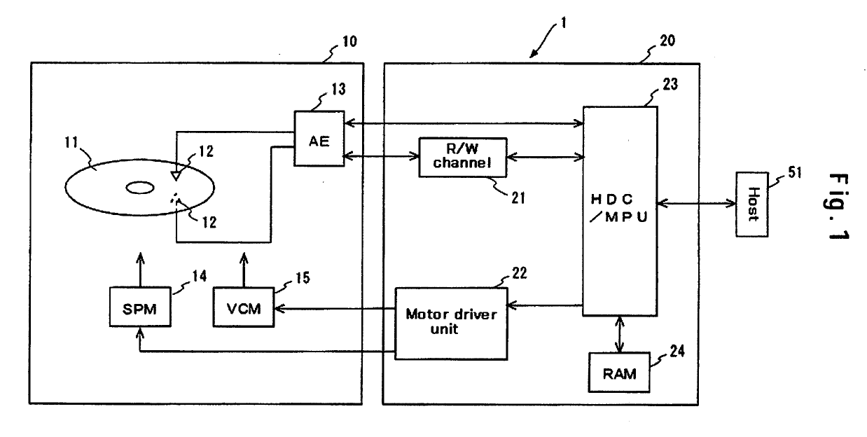

Hereinafter, specific embodiments to which the present invention is applied will be described in detail with reference to the accompanying drawings. To make the present invention more understandable, outline of the overall configuration of a hard disk drive (HDD) which is an example of recording media drives will be described first. FIG. 1 is a block diagram showing a schematic configuration of an HDD 1 according to the embodiment. As shown in FIG. 1, the HDD 1 includes a magnetic disk 11 which is an example of recording media, a head element 12 which is an example of heads, arm electronics (AE) 13, a spindle motor (SPM) 14 and a voice coil motor (VCM) 15 within a hermetically-sealed enclosure 10.

Further, an HDD 100 is provided with a circuit substrate 20 which is fixed on the outer side of the enclosure 10. The circuit substrate 20 includes thereon a read/write channel (R/W channel) 21, a motor driver unit 22, a hard disk controller (HDC)/MPU integrated circuit (hereinafter referred to as HDC/MPU) 23, and ICs including a RAM 24 as an example of memories. It should be noted that each circuit configuration can be integrated into one IC or can be mounted by dividing the circuit configurations into a plurality of ICs.

Write data from an external host 51 is received by the HDC/MPU 23 and is written on the magnetic disk 11 by the head element 12 via the R/W channel 21 and the AE 13. Further, data stored on the magnetic disk 11 is read by the head element 12, and the data thus read is output to the external host 51 from the HDC/MPU 23 via the AE 13 and the R/W channel 21.

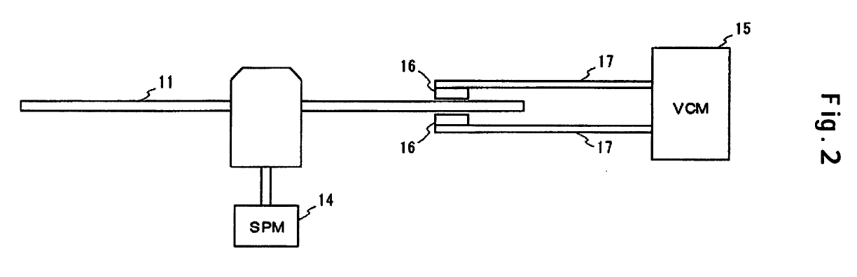

Next, each component of the HDD 100 will be described. First, referring to FIG. 2, the outline of a drive mechanism of the magnetic disk 11 and the head element 12 will be described. The magnetic disk 11 is fixed on the hub of the SPM 14. The SPM 14 rotates the magnetic disk 11 at a prescribed speed. The motor driver unit 22 drives the SPM 14 according to control data from the HDC/MPU 23. The magnetic disk of the embodiment is provided with recording surfaces on which data is recorded on both sides of the disk and the head elements 12 (not shown in FIG. 2) which associate with the respective recording surfaces.

Each head element 12 is fixed on a slider 16. Further, the slider 16 is fixed on a carriage 17. The carriage 17 is fixed on the VCM 15, and the VCM 15, as being pivoted, moves the slider 16 and the head element 12. The motor driver unit 22 drives the VCM 15 according to control data from the HDC/MPU 23.

To enable reading/writing of data from and to the magnetic disk 11, the carriage 17 moves the slider 16 and the head element 12 over the data area on a surface of the rotating magnetic disk 11. As the carriage pivots, the slider 16 and the head element 12 move along with the radial direction on the surface of the magnetic disk 11, thereby enabling the head element 12 to access the desired area.

As a pressure caused by viscosity of air existing between the air bearing surface (ABS) of the slider 16 facing the magnetic disk 11, and the magnetic disk 11 is equal to a force applied to the direction of the magnetic disk by the carriage 17, the slider 16 and the head element 12 fixed thereto fly above the magnetic disk 11 at a uniform distance therebetween. Typically, a write head which converts electric signals to magnetic fields according to data to be stored on the magnetic disk 11 and a read head which converts magnetic fields from the magnetic disk 11 to electric signals are formed on the head element 12 as an integral part. It should be noted that at least one magnetic disk 11 suffices, and the recording surface can be formed on a single side or double sides of the magnetic disk 11.

Next, referring to FIG. 1 again, each circuit will be described. The AE 13 selects one head element 12, among a plurality of head elements 12, through which data accessing is executed, amplifies a read signal to be read by the head element 12 thus selected at a constant gain (pre-amplifying) and sends the signal to the R/W channel 21. Further, the AE 13 sends a write signal from the R/W channel 21 to the selected head element 12.

The R/W channel 21 executes a write process on the data transferred from the host 51. In the write process, the R/W channel 21 executes a code modulation on the write data supplied by the HDC/MPU 23 and further converts the code-modulated write data into a write signal (current), thereby supplying the signal to the AE 13. Further, when supplying data to the host 51, the R/W channel 21 executes a read process. In the read process, the R/W channel 21 amplifies the read signal supplied from the AE 13 so that the signal amplitude can be constant, extracts data out of the read signal thus acquired, and executes a decoding process. The data to be read includes user data and servo data. The decoded read data is supplied to the HDC/MPU 23.

The HDC/MPU 23 is a circuit in which an MPU and an HDC are integrated into one chip. The MPU operates according to micro-codes loaded in the RAM 24, in which, as the HDD 1 starts up, data that is required for control and data processing, in addition to micro-codes that run on the MPU, are loaded from the magnetic disk 11 or a ROM (not shown in FIG. 1). The HDC/MPU 23 executes the overall control of the HDD 1 in addition to processes that are required for data processing such as positioning control of the head element 12, interface control and defect management. In particular, with the embodiment, the HDC/MPU 23 controls switching among power-save modes to reduce consumption power as well as switching between a power-save mode and the active mode. Further a description will be made on this point in detail later.

The HDC/MPU 23 is provided with an interface function with the host 51 and receives user data and commands such as a read command and a write command that are transmitted from the host 51. The user data received is transferred to the R/W channel 21. Further, the HDC/MPU 23 transmits read data that is acquired from the R/W channel 21 and read from the magnetic disk 11 to the host 51. Further, the HDC/MPU 23 executes a process for error correction (ECC) on user data that is acquired from the host 51 or is read from the magnetic disk 11. The HDD 1 according to the embodiment executes sending and receiving of data (including commands, user data and control data) through serial communication. Toward this end, a sequence which is characteristic in terms of controlling power-save modes is executed. Further description will be made on this point in detail later.

Data to be read by the R/W channel 21 includes servo data in addition to user data. The HDC/MPU 23 executes positioning control of the head element 12 by using the servo data. Control data from the HDC/MPU 23 is output to the motor driver unit 22. The motor driver unit 22 supplies driving current to the VCM 15 in accordance with the control signal. Further, the HDC/MPU 23 executes control of read/write processes of data by using the servo data.

Next, power-save mode control of the HDD 1 according to the embodiment and the data communication with the host 51 associated therewith will be described. In particular, a switching process to a power-save mode and a reset process to the active mode (the entire device is in active status) from a power-save mode for a case where switching to a power-save mode accompanying an inactive system clock (referred to as the “sleep mode (clock inactive)” in this specification) will be described.

The HDD 1 according to the embodiment executes data communication, with the host 51, for commands, user data, or control data in a communication protocol through serial data transmission. Serial data transmission requires sending and receiving of data according to a clock signal. For this reason, when a power-save mode accompanying an inactive system clock is established, a clock for data communication is not generated either, and the HDD 1 is unable to receive a request from the host to mode-switch from the power-save mode, or more typically, a command to request resetting to the normal active mode (referred to as the “software reset command” in this specification) cannot be received.

The HDD 1 according to the embodiment executes a mode-switching request by using a control signal which is not based on a clock from the host (referred to as an “out-of-band control signal” in this specification) and executes a reset process from a power-save mode accompanying an inactive system clock; By using the out-of-band control signal that is not based on a clock, the HDD 1 can receive a control signal from the host 51 even while a system clock is inactive.

Further, circuits required for serial data transmission including a clock generator and a serial data transmission interface (serial interface) is activated in responding to the out-of-band control signal. This enables to receive a software reset command through a serial data transmission channel from the host 51. With the arrangement, it is possible to receive the software reset command from the host 51, thus, in responding to the reception thereof, enabling to reset the entire device to the normal active mode.

As stated above, when the host 51 is able to transmit an out-of-band control signal, the HDD 1 can receive a control signal requesting for resetting from a power-save mode even in clock inactive status. Thereafter, the HDD 1 can execute a reset process to the normal active mode from the power-save mode by using the software reset command. However, if the host 51 is not provided with a function to transmit an out-of-band control signal, the HDD cannot receive a command (a command as serial data) via the serial data transmission channel when the clock is inactive. Therefore, in this case, the HDD 1 cannot execute the reset process by using the software reset command.

The HDD 1 according to the embodiment requests the host 51 for approval for the host 51 to execute a reset request using an out-of-band control signal to the HDD 1 when a request for switching to a power-save mode accompanying an inactive clock from the host 51 is received. More specifically, the HDD 1 confirms that the host 51 executes the reset request using the out-of-band control signal, prior to making a reset request using the software reset command. When approval is acquired from the host 51, the HDD 1 is switched to the power-save mode accompanying an inactive clock.

On the other hand, when approval is not acquired from the host 51, the HDD 1 retains circuits required for serial data transmission including a clock generator and a serial interface in active status and suspends only part of other circuits. With the arrangement, it is possible to receive the software reset command from the host 51 and execute a reset process in responding to the reception thereof even when the host 51 does not support out-of-band control signals.

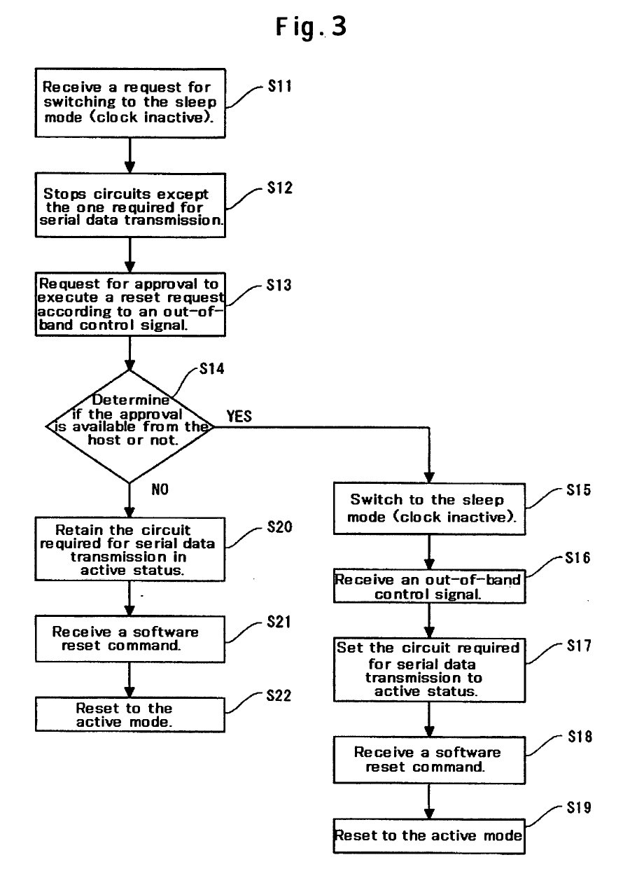

The above-described processes can be implemented by the following sequence, which will be described with reference to a flow chart in FIG. 3. The HDD 1 receives a request from the host 51 to switch to the sleep mode (clock inactive) from the host 51 (S11). The HDD 1 suspends at least part of the internal circuits that are unnecessary to serial data transmission (S12). The HDD 1 requests the host 51 to execute a reset request according to an out-of-band control signal (S13). The HDD 1 determines if the approval is available from the host 51 or not (S14).

When the approval is available, the HDD 1 stops a clock and switches to the sleep mode (clock inactive) (S15). In the reset process, the HDD 1 receives an out-of-band control signal from the host 51 (S16). The HDD 1 sets the internal circuits that are required for serial data transmission in active status (S17) and receives a software reset command from the host 51 (S18). The HDD 1 is reset to the normal active mode according to the software reset command (S19).

On the other hand, when the approval is not available, the HDD 1 retains the internal circuits required for serial data transmission in the active status (S20). When the software reset command is received from the host 51 (S21), the internal circuits that were suspended are restarted and reset to the normal active mode (S22).

The power-save mode control according to the embodiment is suitable particularly for the Serial ATA (SATA) Specification which stipulates a method of transferring data between a data storage device and the host 51. By applying the power-save mode control of the embodiment to a data storage device conforming to the SATA Specification, or to a system conforming to the SATA Specification comprising a data storage device and the host 51, an HDD is enabled to be switched to a power-save mode accompanying an inactive clock and further reset to the normal active mode according to a reset command (software reset) through serial data transmission from the host 51.

Even for a case where the host 51 does not conform to the SATA Specification, it is also enabled to switch an HDD to a prescribed power-save mode and further reset the HDD to the active mode according to a reset command from the host 51 via serial data transmission. It should be noted that, hereafter, the embodiment will be described by referring to the SATA Specification as required. However, the scope of the present invention will not be limited to the SATA.

Hereinafter, the power-save mode control of the embodiment will be described in detail with reference to the accompanying drawings. The HDD 1 of the embodiment is provided with a plurality of power-save modes and, as stated above, power modes of the serial interface can be controlled independently from other circuits. In addition, the HDD 1 is provided with an overall HDD power-save mode accompanying an inactive system clock (sleep mode (clock inactive)) and an overall HDD power-save mode without accompanying an inactive system clock (sleep mode (clock active)).

The HDD 1 is further provided with two different power-save modes which suspend circuits of the serial interface. The power-save modes of the serial interface include a serial interface partial suspend mode which suspends part of the circuits, and a serial interface suspend mode which suspends other circuits in addition to the circuits that are suspended by the serial interface partial suspend mode. When a description is made by taking the SATA as an example, the Partial state is an example of partial suspend modes and the Slumber state is an example of suspend modes of the serial interface. It should be noted that an HDD may be provided with other power-save modes.

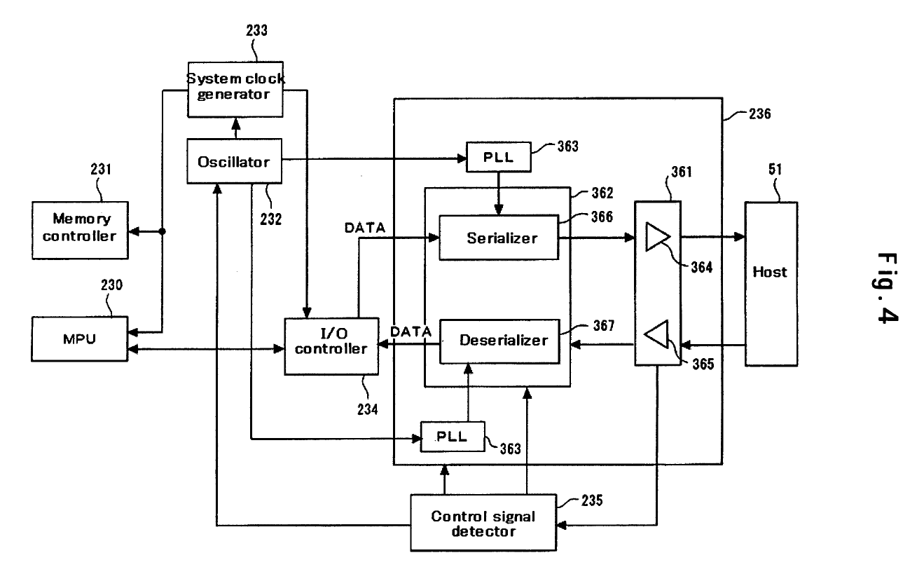

FIG. 4 is a block diagram showing a schematic configuration of part of circuits in the HDC/MPU 23 according to the embodiment. The HDC/MPU 23 includes an MPU 230, a memory controller 231 which controls data transfer to and from a memory, an oscillator 232, a system clock generator 233 which generates a system clock based on a signal from the oscillator, an I/O controller 234 which controls communication with the host 51, a control signal detector 235 which detects an out-of-band control signal from the host 51, and a serial interface 236 which interfaces serial data transfer with the host 51.

The serial interface 236 includes an analog front-end 361, a serializer/deserializer 362 and a PLL 363. The analog front-end 361 incorporates a transmitter 364 and a receiver 365. The serializer/deserializer 362 includes a serializer and a deserializer 367. The serializer 366 is an example of transmitters which convert parallel data to serial data and output the data to the analog front-end 361. The deserializer 367 is an example of receivers which convert serial data from the analog front-end 361 to parallel data.

The PLL 363 generates a clock signal for serial data communication based on a signal from the oscillator 232 and supplies the signal thus generated to each of the serializer 366 and deserializer 367. The deserializer 367 executes a serial-parallel conversion in accordance with an internal clock signal which is synchronized with a clock signal that is embedded in the serial data received.

In the sleep mode (clock inactive), all circuits except the analog front-end 361 and the control signal generator 235 among the circuits shown in FIG. 4 are shut down. More specifically, the respective circuits of the MPU 230, the memory controller 231, the oscillator 232, the system clock generator 233, the I/O controller 234, the serializer/deserializer 362 and the PLL 363 are shut down. In the sleep mode (clock inactive), such other circuits including the R/W channel 21 and the motor driver unit 22 are also shut down (and the VCM 15 and SPM 14 accordingly) in addition to the above-stated circuits. Here, shutdown of a logical circuit implies stopping of clock supply. However, it is also possible to shut down power supply only.

In the sleep mode (clock active), the memory controller 231 among the circuits shown in FIG. 4 is shut down and other circuit configurations are in operating status. The R/W channel 21, the motor driver unit 22 and so on are in suspend status. Since the oscillator 232 and the system clock generator 233 are operating, a clock is kept generated. In addition, since the serial interface 236 is operating, it is possible to receive a command from the host 51 through serial data transmission channel.

In the serial interface partial suspend mode, the serializer/deserializer 362 are shut down and the PLL 363 and the analog front-end 361 are in operating status. In the serial interface suspend mode, the PLL 363 is shut down in addition to the serializer/deserializer 362, but other circuits are in operating status. Comparing to the serial interface partial suspend mode, in general the serial interface suspend mode consumes less power, but it requires much more time before being reset to the active mode.

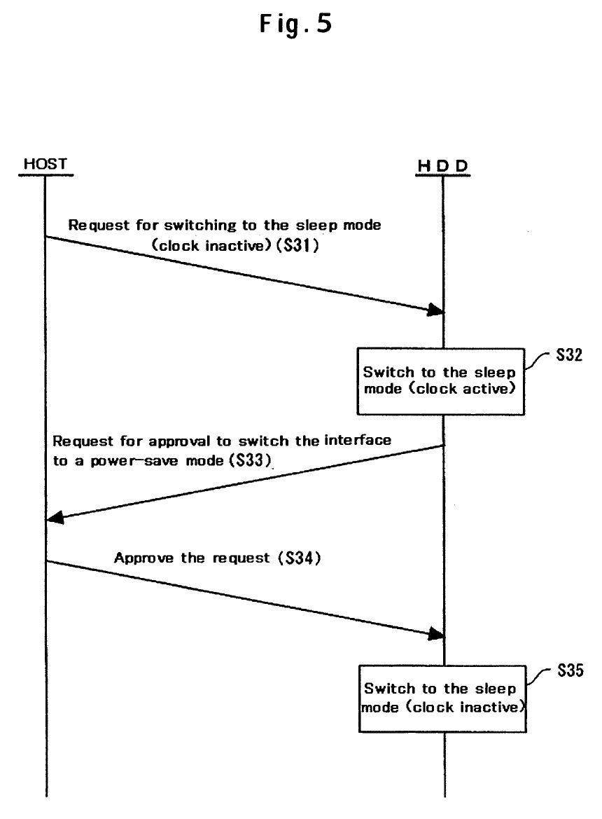

Hereinafter, a process for a case where a request switching to the sleep mode (clock inactive) is transmitted to the HDD 1 from the host 51 will be described. First, referring to a sequence diagram in FIG. 5, a case where the host 51 supports an out-of-band control signal will be described. More specifically, in the status where a serial data communication link is not established, the host 51 is able to request the HDD 1 for resetting from a power-save mode.

Referring to FIG. 5, a serial data communication link is established between the HDD 1 and the host 51 and a serial data transmission channel (serial bus) is active. First, the host 51 transmits a request switching to the sleep mode (clock inactive) to the HDD 1 (to be output on the serial bus) (S31). The HDD 1, in responding to the request switching to the sleep mode (clock inactive) from the host 51, is switched to the sleep mode (clock active) (S32).

In the sleep mode (clock active), the serial interface 236, the MPU 230 and the I/O controller 234 are operating. Therefore, the HDD 1 can execute data transfer with the host 51 through serial data transfer. The HDD 1 requests the host 51 through serial data transfer for approval for the serial interface 236 to be switched to a power-save mode (S33). The request for approval for switching corresponds to a request to the host 51 to approve the fact that the host 51 transmits an out-of-band control signal to the HDD 1 (for resetting from the power-save mode).

Since the host 51 supports an out-of-band control signal (or power management of the serial interface), when the host 51 receives a request switching to a power-save mode, the host 51 approves switching of the serial interface 236 to the power-save mode and transmits an approval response to the HDD 1 (S34).

Upon receiving the approval from the host 51, the HDD 1 switches the sleep mode (clock active) to the sleep mode (clock inactive) (S35). More specifically, the HDD 1 stops generating a system clock and a clock for serial data communication and shuts down the respective circuits of the serial interface 236, the MPU 230 and the I/O controller 231. With the embodiment, the serial interface 236 is set to the same status as the interface suspend mode. The analog front-end 361 is supplied with power and is retained in operating status. It should be noted that, depending on system designs, it is also possible to set the serial interface 236 to the partial suspend mode, although such arrangement is inferior in terms of electric power saving.

Hereinafter, details of each process in the above-described sequence will be described. First, a sleep mode (clock active)-switching process of the HDD 1 (S32) will be described. When a request switching to the sleep mode (clock inactive) is transmitted to the HDD 1 from the host 51 (S31), the analog front-end 361 receives the request. The request switching to the sleep mode (clock inactive) received is serial-parallel converted by the deserializer 367. The request switching to the sleep mode (clock inactive) is then transferred to the I/O controller 234, and the I/O controller 231 notifies the MPU 230 of reception of the request. The MPU 230 interprets the request from the host 51 and, in responding to the request switching to the sleep mode (clock inactive), outputs a control signal to shut down the prescribed circuits described above such as the memory controller 231, the R/W channel 21 and the motor driver unit 22. As a result, the prescribed circuits are shut down.

Next, a process to request for approval to switch the serial interface 236 to a power-save mode (S33) will be described. The MPU 230 generates a request for approval of switching the serial interface 236 to a power-save mode according to a micro code and outputs the request the I/O controller 234. The request for approval of switching that is input to the serializer 366 from the I/O controller 234 is serial converted and transferred to the host 51 from the analog front-end 361 via a serial communication transmission channel. When a description is made by way of example of the SATA, the “PMREQ primitive” is an example of the request for approval of switching the serial interface 236 to the power-save mode.

As stated above, the host 51 makes a reply for approval to the request for approval of switching the serial interface 236 to the power-save mode (S34), and, when a description is made by way of example of the SATA, the “PMACK primitive” corresponds to an example of the approval reply from the host 51.

In the process switching to the sleep mode (clock inactive) from the sleep mode (clock active) (S35), the approval from the host 51 is received by the analog front-end 361. The approval thus received is serial-parallel converted by the deserializer 367 and is further transferred to the I/O controller 234. The I/O controller 234 switches the serial interface 236 to the suspend mode in responding to acquisition of the approval of switching the serial interface 236 to the power-save mode from the host 51. Further, the I/O controller 234 notifies the MPU 230 of completion of switching the serial interface 236 to the suspend status. The MPU 230, in responding to the completion notification, instructs the oscillator 232 to shut down. As a result, generation of the clock is stopped and the MPU 230 and the I/O controller 234 are shut down. This completes switching to the sleep mode (clock inactive).

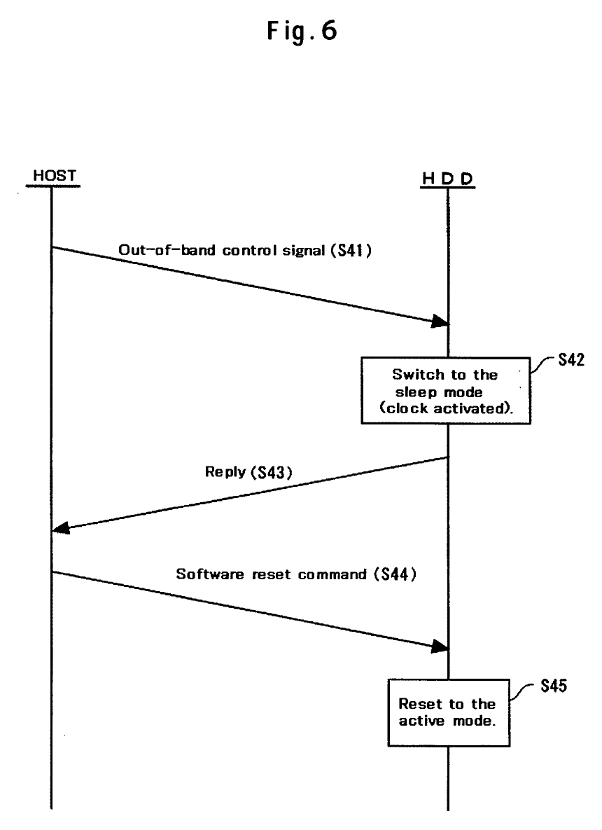

Next, a resetting process that resets the normal active mode from the sleep mode (clock inactive) will be described with reference to the sequence diagram of FIG. 6. A serial data communication link is not established between the HDD 1 and the host 51 and the serial data transmission channel are inactive. First, the host 51 issues a control signal (an out-of-band control signal) that is not based on a clock signal on the serial data transmission channel to switch the HDD 1 to the normal active mode from the sleep mode (clock inactive) (S41).

The analog front-end 361, since it is in operating status, can receive the out-of-band control signal. The HDD 1 receives the out-of-band signal and, in responding to the out-of-band signal, reactivates the circuits required for serial data communication such as the serial interface 236 and the MPU 230 with the host 51 (S42). The HDD 1 itself is put in the status similar to the sleep mode (clock active).

When being put in the status that enables data communication through serial data transmission with the host 51, the HDD 1 transmits a reply to the out-of-band control signal to the host 51 (S43). Then, the host 51 transmits a software reset command (a reset request) through serial data transmission to the HDD 1 (S44). The HDD 1 receives the software reset command, reactivates according to the software reset command each circuit that was in suspend status in the HDD 1, and resets itself to the normal active status (S45).

With the sequence stated above, it is possible to reset the HDD 1, which is in the sleep status in which the clock is stopped and data communication through serial data transmission is disabled, to the normal active mode.

Hereinafter, each process in the above-described reset sequence will be described in detail. In the step S42, the out-of-band control signal issued by the host 51 is received by the analog front-end 361 of the HDD 1. The out-of-band control signal can be configured, for example, with a plurality of burst signals having prescribed intervals. When taking the SATA as an example, the “COMWAKE signal” corresponds to an example of out-of-band control signals which are signals to control the reset request. The COMWAKE signal is a signal used to reset the serial interface 236 to the active mode from the power-save mode.

The control signal is transferred to the control signal detector 235 from the analog front-end 361. The control signal detector 235, in responding to the control signal from the power-save mode, instructs the oscillator 232 and the system clock generator 233 to restart, and thus a system clock is generated. As a result of the system clock generation, the MPU 230 and the I/O controller 234 restart. In addition, in responding to the instruction from the control signal generator 235, the serial interface 236 including the PLL 363 and the serializer/deserializer 367 restarts, whereby the status is established where the HDD 1 can execute serial data communication with the host 51.

When the I/O controller 234 transmits a reply to the out-of-band control signal to the host 51 via the analog front-end 361 (S43), the host 51 transmits a software reset command in the form of serial data to the HDD 1 (S44). In the step S45, the software reset command transmitted from the host 51 is received by the analog front-end 361. The software reset command is serial-parallel converted by the deserializer 367 and is transferred to the MPU 230 via the I/O controller 234. The MPU 230 interprets the software reset command thus acquired according to a micro code and, in responding to the interpretation, outputs a control signal instructing restart of the suspended circuits in the HDD 1. In responding to the instruction from the MPU 230, the circuits including the R/W channel 21 and the motor driver unit 22 that were in suspend status are switched to operating status. This completes switching to the normal active mode.

Next, a case where the host 51 does not support out-of-band control signals will be described. More specifically, the host 51, in the status where a serial data communication link is not established (a case where the serial interface 236 is in a power-save mode), cannot request the HDD 1 to be reset from the power-save mode. It should be noted that the host 51 can switch the HDD 1 to the normal active mode by means of hardware reset which is a direct control signal to circuits (e.g., COMRESET in the SATA is an example). However, since the hardware reset initializes the control circuit of the HDD 1, a resetting process by means of software reset from the host 51 is required.

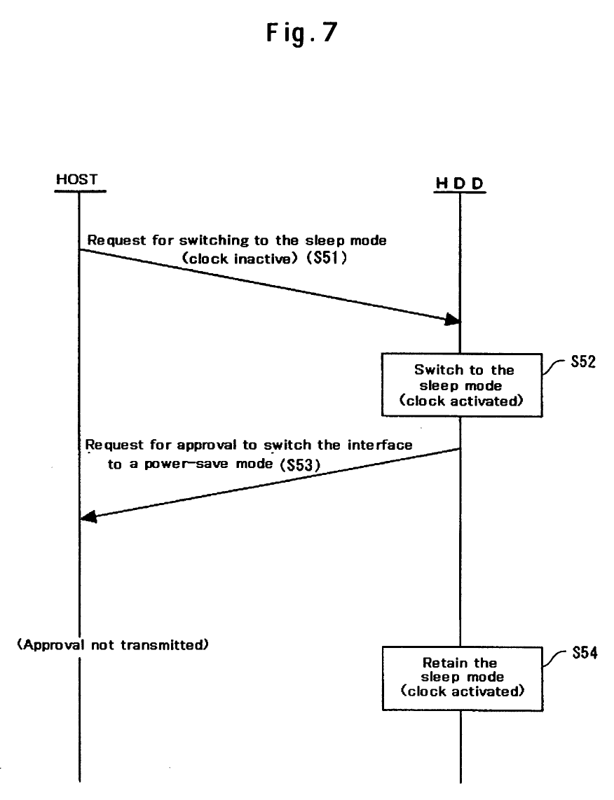

Hereinafter, a description will be made with reference to a sequence diagram in FIG. 7. A serial data communication link is established between the HDD 1 and the host 51 and a serial data transmission channel is active. First, the host 51 transmits a request for switching to the sleep mode (clock inactive) through serial data transfer to the HDD 1 (S51). The HDD 1, in responding to the request for switching to the sleep mode (clock inactive) from the host 51, is switched to the sleep mode (clock active) (S52).

The HDD 1 requests the host 51 through serial data transmission to switch the serial interface 236 to a power-save mode (S53). The host 51 does not support out-of-band control signals. For this reason, even upon receiving a request for switching to a power-save mode, the host 51 does not transmit an approval reply to the HDD 1. The HDD 1 which cannot receive the approval from the host 51 is retained in the sleep mode (clock active) without being switched to the sleep mode (clock inactive) (S54). The detailed description of each process in the sequence will be omitted here since each process is practically similar to each corresponding process in the case where the host 51 supports out-of-band control signals.

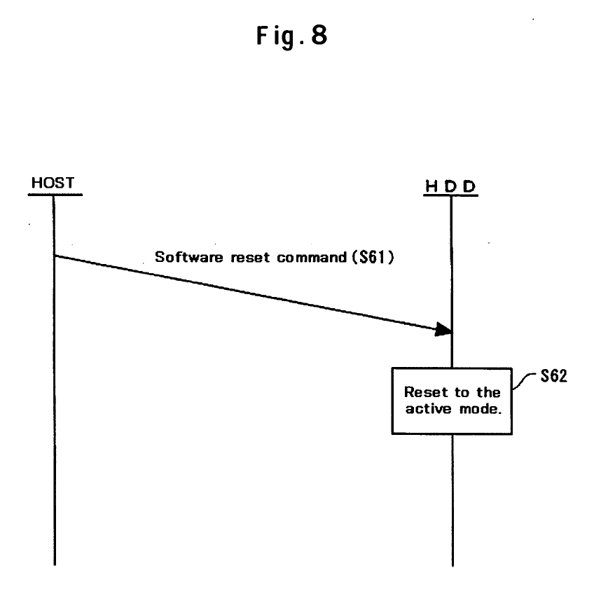

Hereinafter, a reset process to reset the sleep mode (clock active) to the normal active mode will be described with reference to a sequence diagram in FIG. 8. A serial data communication link is established between the HDD 1 and the host 51 and a serial data transmission channel is active. Specifically, the HDD 1 can execute data communication with the host 51 through serial data transmission.

The host 51 transmits a software reset command (a reset request) through serial data transmission to the HDD 1 (S61). The HDD 1 receives the software reset command, restarts each suspended circuit in the HDD 1 according to the software reset command, and resets itself to the normal active status (S62). The detailed description of each process in the sequence will be omitted here since each process is practically similar to each corresponding process in the case where the host 51 supports out-of-band control signals.

As stated above, for a case where the host 51 does not support power management of the serial interface 236 and therefore a control signal that is not based on a clock cannot be output, the HDD 1 retains circuits to execute serial data transmission in the active status. Consequently, the HDD 1 can receive a software reset command from the host 51 and, in responding to such reception, reset itself to the normal active mode. It should be noted that, in a case where the host 51 supports out-of-band control signals, the host 51 can reply with a refusal to the approval request from the HDD 1.

As described above, the present invention is described by taking specific embodiments as examples. However, the present invention is not limited to the above-stated embodiments. For example, the present invention is not limited to the SATA protocol. Further, the relationship between each process and the logical composition is not limited to the above-described examples. Designers can design storage devices by utilizing effective functions and circuit configurations. In the present embodiments, the head element 12 is a read/write head which is capable of executing writing and reading processes, but the present invention is also applicable to a read-only device which is designed to execute reading data only. In the embodiments, an example in which switching is made to the normal active mode from the sleep mode (clock inactive) has been described, but the techniques of the embodiment can also be applied to a case where switching is made to other modes from the sleep mode (clock inactive). It should be noted that the present invention is particularly useful for magnetic disk storage devices, but it is also applicable to other modes of storage devices which drive storage media, including optical disk storage devices.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims alone with their full scope of equivalents.

What is claimed is:

1. A recording media drive which executes serial data communication with a host according to a clock, said recording media drive comprising:
a receiver which receives from the host a request switching to a power-save mode accompanying an inactive system clock;
a transmitter which transmits, in responding to said switching request received, an approval request for said host to execute a mode-switching request according to a control signal that is not based on a clock to said host through said serial data communication;
a controller which instructs, when judging that the approval is received from said host, an internal circuit to stop the system clock and to be switched to said power-save mode; and
a system clock generator which stops generating a system clock in responding to the instruction from said controller.

2. A recording media drive according to claim 1,
wherein said controller, when judging said approval is not received, does not instruct the stopping of the system clock, and
wherein said system clock generator continues generating a system clock.

3. A recording media drive according to claim 1, further comprising:
a control signal detector which instructs resetting of a circuit required for said serial data communication when said control signal from said host is detected.

4. A recording media drive according to claim 3,
wherein said receiver is reset by an instruction from said control signal detector,
wherein said receiver receives a mode-switching request from said host through said serial data communication, and
wherein said media drive is switched to a mode associated with the mode-switching request received through said serial data communication.

5. A recording media drive according to claim 4,
wherein said mode-switching request requests resetting of said media drive to an active mode.

6. A recording media drive according to claim 4,
wherein in responding to the switching request to said power-save mode, at least part of the internal circuit that is unnecessary for said serial data communication is shut down.

7. A recording media drive according to claim 3,
wherein, when said control signal from said host is detected, at least part of the internal circuit is retained in suspend status.

8. A recording media drive according to claim 3,
wherein according to an instruction from said control signal, said receiver, said transmitter, said system clock generator and said controller are reset and at least part of the internal circuit is retained in suspend status,
wherein said receiver receives a mode-switching request from said host through said serial data communication, and
wherein said controller instructs the internal circuit to be switched to a mode associated with the mode-switching request received through said serial data communication.

9. A recording media drive according to claim 1,
wherein, to ensure approval to execute a mode-switching request from said host according to said control signal that is not based on a clock, approval for switching said transmitter and said receiver to the power save mode is requested, and,
wherein, in responding to reception of the approval for said request from said host, said transmitter and said receiver are switched to the power-save mode, and said system clock is stopped.

10. A recording media drive which executes serial data communication with a host according to a clock, said recording media drive comprising:
a receiver which receives a request switching to a power-save mode accompanying an inactive system clock;
a transmitter which transmits, in responding to said switching request received, an approval request for said host to execute a reset request signal that is not based on a clock to said host through said serial data communication;
a controller which outputs a shutdown instruction of part of an internal circuit in responding to said switching request and judges if said approval from said host is received or not; and
a system clock generator which, when said controller judged said approval is not received, continues generating a system clock.

11. A recording media drive according to claim 10, wherein the controller puts at least part of an internal circuit that is unnecessary for said serial data communication in suspend status, in responding to the request switching to said power-save mode.

12. A control method for a power-save mode in a recording media drive which executes serial data communication with a host according to a clock, said control method comprising:
receiving a request switching to the power-save mode accompanying an inactive system clock;
requesting approval for said host to transmit a control signal that is not based on a clock to said host; and
stopping said system clock in responding to reception of said approval from the host.

13. A control method according to claim 12, further comprising:
receiving said control signal from said host;
restarting a circuit required for the serial data communication in responding to said control signal;
receiving a mode-switching request through the serial data communication from said host; and
switching to a mode associated with the mode-switching request received through said serial data communication.

14. A control method according to claim 13,
wherein, in responding to said control signal, the circuit required for said serial data communication is restarted while part of an internal circuit is retained in suspend status.

15. A control method according to claim 12, further comprising shutting down part of an internal circuit in responding to reception of the request switching to said power-save mode.

16. A control method according to claim 12,
wherein said mode-switching request received through said serial data communication requests resetting of said recording media drive to a normal active mode.

17. A control method according to claim 12,
wherein, to ensure approval for said host to transmit said control signal that is not based on a clock, approval for switching a serial interface to the power-save mode is requested, and in responding to reception of the approval for said request from said host, said serial interface is switched to the power-save mode, and said system clock is stopped.

18. A control method for a power-save mode in a media drive which executes serial data communication with a host according to a clock, said control method comprising:
receiving from the host a request switching to the power-save mode accompanying an inactive system clock;
requesting to the host approval for said host to transmit a control signal that is not based on a clock; and
continuing generating said system clock when said approval is not received from said host.

19. A control method according to claim 18, further comprising:
putting at least part of an internal circuit that is unnecessary for said serial data communication in suspend status, in responding to the request switching to said power-save mode.
